(19) United States
(12) Patent Application Publication
(10) Pub. No.: US 2006/0271631 A1
(43) Pub. Date: Nov. 30, 2006

(54) Categorizing mails by safety level

(75) Inventors: Imran I. Qureshi, Milpitas, CA (US); Elizabeth I. Powers-Boyle, San Francisco, CA (US); Pablo M. Stern, San Francisco, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/136,989

(22) Filed: May 25, 2005

(51) Int. Cl. G06F 15/16

(52) U.S. Cl. 709/206

(57) ABSTRACT

A multiple tier system is provided for classifying the safety level of an electronic message. The multiple tier system can include safety classification levels of safe, medium safe, and unsafe. Display settings associated with each safety level govern how messages are initially displayed to a user. A user interface distinguishes messages using a safety information interface. The safety information interface provides information about the message and allows a user to provide input regarding the desirability of the message. Upon receiving user input, the safety level of the message may be changed and other processing related to the message can be performed. The system also provides a mechanism for detecting and unsubscribing from a mailing list.

### BACKGROUND OF THE INVENTION

1. Field of the Invention

The present invention is directed to processing electronic messages in an electronic message provider system.

2. Description of the Related Art

Reducing the spam or unsolicited commercial email (UCE) that is sent to users of a mail service has been a major problem for mail service providers for some time. Additionally, email sources posing as a legitimate company often attempt to persuade users to open damaging emails sent to the user. Once a user opens the mail, the email proceeds to download graphics from a server. To download the graphics, a request is sent from an application (such as a browser application) on the user's computer to a server providing the graphics. When the server receives the graphics request from the mail application, the sender knows that the recipient address is a valid email account that is used by a person who has opened the email. The sender of the email can then sell this information (the valid recipient address) to spammers and/or use it for their own benefit.

In yet another fraudulent use of email called “phishing”, an email may contain content informing the user that certain identification, financial or personal information is needed for some account (for example, a credit card to confirm the user's email account, a credit card and password to confirm a bank account or online payment account). The emails provide a hyperlink that users can select. Once selected, the user is presented with an appropriate page to submit their information. The hyperlink in these emails directs the user to a web site associated with the perpetrator. The web site often looks very much like a legitimate company's web site. Many users are fooled by this type of email and provide the requested financial or personal information. The perpetrators can then sell the user's information, engage in identity theft of the user, and cause other financial harm and inconvenience to the user.

A few companies have implemented solutions to prevent these fraudulent uses of email. For example, some companies do not download graphics within a received email viewed by a user. These solutions only download the graphics from a web server and show them in the email once the user chooses to download them. In addition, some services attempt to confirm that a received email comes from the sender it claims to have originated from. Examples of this type of service include Sender ID from Microsoft Corporation of Redmond, Wash., and DomainKeys Identified Mail (DKIM), developed by Yahoo! Incorporated of San Jose, Calif. and Cisco Systems, Inc., of San Jose, Calif. The problem with these ad-hoc solutions is that many users do not understand the technologies or the threat these emails pose them, and new technologies must be introduced often to combat new types of email-based threats. As a result, the current solutions for combating fraudulent use of email are often too complex for the casual user of an email service.

### SUMMARY OF THE INVENTION

In one embodiment, the invention herein implements a multiple tier system for classifying the safety level of an electronic message. The multiple tiered system may include safety classification levels of safe, medium, and unsafe. A user interface can distinguish between classification levels using a safety information interface. The safety information interface provides information about the message and allows a user to provide input regarding the desirability of the message. In addition to having a safety information interface, messages having a different safety classification can be displayed according to tiered display settings. Depending on the message safety level, the display settings can disable hyperlinks and attachments as well as prevent certain portions of the message from being displayed to user. An algorithm can be used to determine whether received messages are from a known source and whether they pass a source domain query (or come from a system not compatible with the source domain system). Each message is then rated based on the results of the analysis. The message rating, or safety level, is then used to define the options for viewing and interacting with the message.

In one embodiment, a method for processing a message begins with receiving a message. Next, one of at least three safety levels is selected for the received message. Safety level information is then provided in an interface. The safety level information is associated with the selected safety level.

In another embodiment, a method for providing an electronic mail service begins with providing a plurality of mail servers by an electronic mail provider. The plurality of mail servers then receives an electronic message for a user having an account with the electronic mail provider. Next, the plurality of mail servers determines one of at least three safety levels for the message. An interface is then provided for the user. The interface has safety level information associated with the selected safety level.

In another embodiment, one or more processor readable storage devices having processor readable code embodied on one or more of the processor readable storage devices is used to implement the invention. The processor-readable code is used for programming one or more processors to perform a method. The method begins with accessing an electronic message sent to a recipient from a sender. Next, a safety level of the electronic message is determined. The electronic message is then processed in response to receiving safety level input from a user.

### BRIEF DESCRIPTION OF THE DRAWINGS

FIG. 1 illustrates an embodiment of a system for determining the safety level of a message received for a user.

FIG. 2 illustrates an embodiment of a computing environment for implementing the present invention.

FIG. 3A illustrates an embodiment of a method for determining safety level information for a message received for a user.

FIG. 3B illustrates an embodiment of a table having message display settings for different safety levels.

FIG. 4 illustrates an embodiment of a method for determining message safety levels.

FIG. 5 illustrates an example of a mail inbox user interface for a message having a safety level of safe.

FIG. 6A illustrates an example of a mail inbox user interface for a message having a safety level of medium safe.

FIG. 6B illustrates an example of a mail inbox user interface providing supplemental safety level information in a safety information interface for a medium safe message.

FIG. 7 illustrates an example of a mail inbox user interface for a message having a safety level of unsafe.

FIG. 8 illustrates an example of a mail inbox user interface for a message associated with a mailing list.

FIG. 9 illustrates an embodiment of a method for processing a message identified as a newsletter.

FIG. 10A illustrates an embodiment of a method for processing a message after the message has been identified as non-desirable.

FIG. 10B illustrates an embodiment of a method for processing a message that has been identified as non-desirable.

FIG. 10C illustrates a method for processing a message that has been identified as non-desirable.

FIG. 11 illustrates an embodiment of a method for processing a junk request by a mail server.

FIG. 12A illustrates an embodiment of a method for processing a message after it has been identified as desirable.

FIG. 12B illustrates an embodiment of a method for processing a message after it has been identified as desirable.

FIG. 13 illustrates an embodiment of a method for processing a not junk request received by a mail server.

### DETAILED DESCRIPTION

A multiple tier system is provided for classifying the safety level of an electronic message. The multiple tier system can include safety classification levels of safe, medium, and unsafe. A user interface distinguishes messages using a safety information interface. The safety information interface provides information about the message and allows a user to provide input regarding the desirability of the message. An algorithm can be used to determine whether received messages are from a known source and whether they pass a source domain query (or come from a system not compatible with the source domain system). For example, the source domain query may be provided by a service such as SenderID or DKIM. Each message is then rated with a safety level based on the results of the analysis. Display settings associated with each safety level govern how messages are initially displayed to a user. Once the message is displayed, a user may provide input regarding whether the message is desirable or not. Based on the input, processing may be performed to the message. Additionally, user preferences for processing subsequent received messages may be adjusted.

As discussed above, the plurality of safety levels for a message may include safe, medium-safe, and unsafe. A “safe” safety level indicates that a message has not been identified to contain undesirable content or be received from an undesirable source. Safe messages may include messages received from a sender listed in a user's contact list, allowed senders list, or allowed mailing lists. A safe message may also include a message a user has selected to allow. All content will be shown in messages classified as “safe.” A message having a safety level of “medium” safe may or may not be received from an undesirable source or include undesirable content. In one embodiment, at least a portion of the content of a medium safe message will be displayed. In addition to displaying a portion of the content, a safety information interface can be provided to the user. The safety information interface may include elements such as example user-selectable links. The user-selectable links or buttons (hereinafter, collectively referred to as “links”) enable the user to indicate the desirability of the message. For example, links can allow the user to indicate whether a message should be kept (allowed) or moved to a user's junk folder (marked as junk). A message having a safety level of “unsafe” has been determined to either come from an undesirable source or to have undesirable content. A message may be classified as unsafe automatically or after receiving user input that the message or sender is undesirable. When messages having a safety level of unsafe are displayed, all or a portion of their content are withheld from the user. This is advantageous to users because it protects them from fraud and identity theft as well as preventing them from seeing content that may be offensive to them. These messages can be moved directly to a user's junk mail folder upon receipt by the mail provider system.

A received message may be identified as being associated with a mailing list. In this case, the user received the message because the user's email is listed in a mailing list. If input is received from the user indicating the message from the mailing list is undesirable, the user can be automatically unsubscribed from the mailing list. In one embodiment, an unsubscribe email address is retrieved from the received message. The user is unsubscribed by sending a message to the retrieved unsubscribe email address. Automatically sending a message to an unsubscribe email address associated with a received mailing list message is discussed in more detail below.

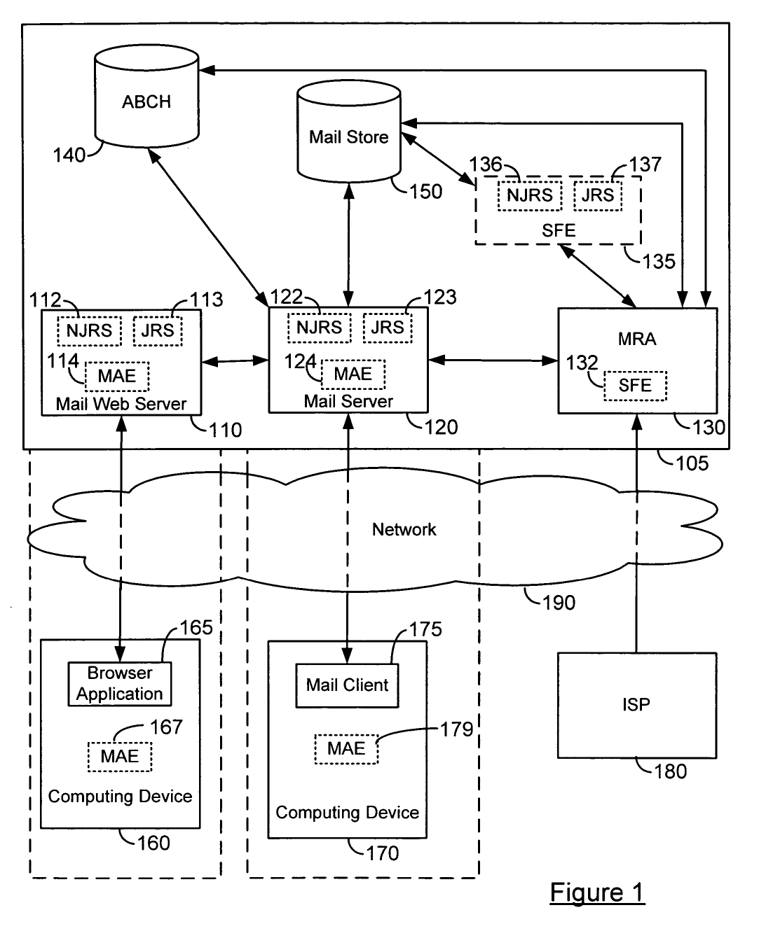

FIG. 1 illustrates an embodiment of a system 105 for providing a system able to determine the safety level of a message received for a user. In one embodiment, system 105 is provided by a mail server provider. FIG. 1 includes mail service provider system 105, network 190, computing device 160 in communication with system 105, computing device 170 in communication with system 105, and internet service provider (ISP)180 in communication with system 105. Computing device 160, computing device 170, and ISP 180 communicate with system 105 over network 190. In one embodiment, network 190 may be the Internet.

System 105 includes mail web server 110, mail server 120, mail receiving agent (MRA) 130, address book clearing house (ABCH) 140, mail store 150, and spam filtering engine (SFE) 135. System 105 may implement a Not Junk Reporting Service (NJRS) and a Junk Reporting Service (JRS). An NJRS is used to process requests regarding messages to be moved out of a junk mail folder. A JRS is used to process requests regarding messages to be moved into a junk mail folder (for example, from a user's junk folder to the user's inbox). As illustrated in system 105 of FIG. 1, both an NJRS and JRS may be implemented in any of several locations within system 105. For example, an NJRS and JRS can be implemented within mail web server 110, mail server 120, and SFE 135. In another embodiment, a single reporting system may implement both a JRS and an NJRS. In this case, separate reporting systems are not needed to process requests to move messages between a junk mail folder and other folders.

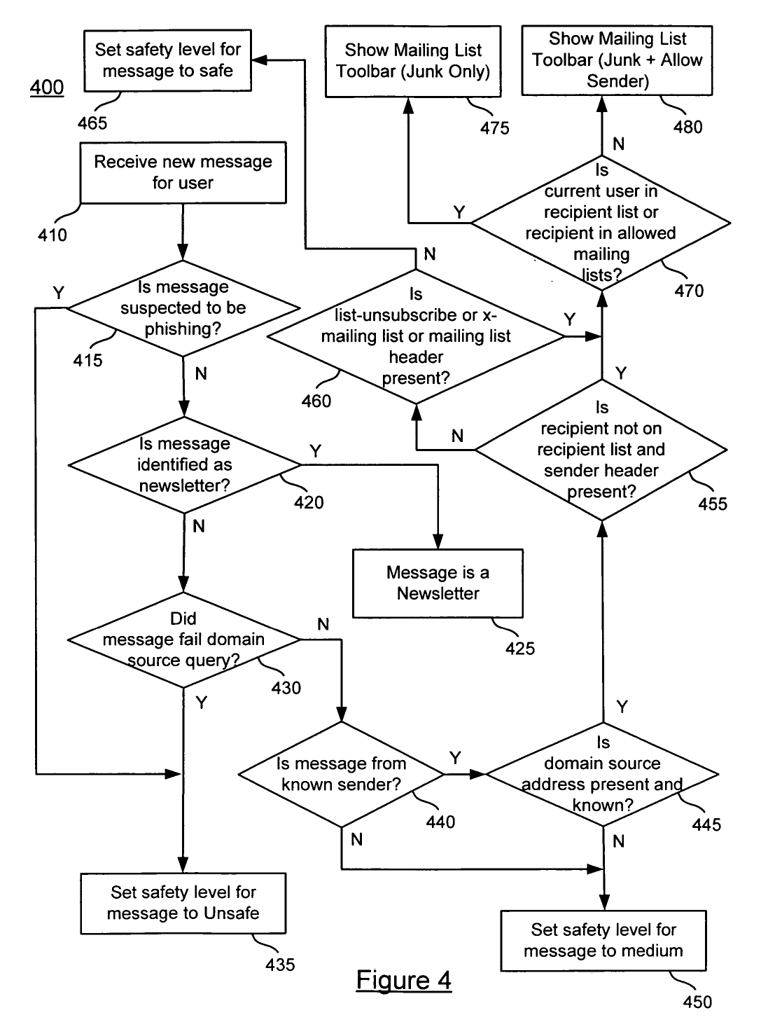

Mail web server 110 may transmit and receive messages with mail server 120 and computing device 160. Mail web server 110 includes NJRS 112, JRS 113, and a message analysis engine (MAE) 114. An MAE is used to analyze a received message and determine a safety level to associate with that message. As with the JRS and NRS, an MAE may be implemented in any of several locations within and outside system 105. For example, an MAE may be implemented within mail web server 110, mail server 120, computing device 160 and computing device 170. Operation of an MAE is described in more detail below with respect to FIG. 4.

Mail server 120 may transmit and receive messages with ABCH 140, mail store 150, mail web server 110, MRA 132 and computing device 170. Mail server 120 includes NJRS 122, JRS123 and MAE 124. As indicated in FIG. 1, all three components illustrated within mail server 120 are optional.

MRA 130 receives incoming messages for users having an account with the mail service provided by the mail service provider of system 105. In addition to receiving user messages, MRA 130 may transmit and receive messages with mail server 120, SFE 135, ABCH 140 and mail store 150. MRA 130 may include spam filter engine (SFE) 132. An SFE filters received messaged based on whether or not they are identified as spam or unsolicited commercial email (UCE).

SFE 135 filters received messaged to determine if they are spam or UCE. SFE 135 includes NJRS 136 and JRS 137. SFE 135 may receive and transmit messages with MRA 130 and mail store 150. As illustrated in FIG. 1, SFE may be implemented within an MRA or as a separate server.

Computing device 160 includes browser application 165. Optionally, computing device 160 may also include MAE 167. In this case, MAE 167 may be implemented with JavaScript or some other script language. When implemented as JavaScript, MAE 167 may be implemented within browser application 165. In a web based email system, MAE 167 is part of system 105 as indicated in FIG. 1.

Computing device 170 includes mail client 175. Optionally, computing device 170 may also include MAE 179. In this case, MAE 179 is stored in the memory of computing device 170 and implemented as part of mail client 175. In a client based system, MAE 179 is part of system 105 as indicated in FIG. 1.

In operation, a message for a user of the mail service provided by system 105 is received by MRA 130. The received message is sent to system 105 by ISP 180 over network 190. Once received, MRA 130 may filter the message to determine if it is considered spam, a UCE or some other type of undesirable message. In another embodiment, the received message is forwarded to SFE 135, where the received message is analyzed to make this determination. MRA 130 also determines if the recipient address for the message is a valid address. In one embodiment, this determination is made by querying ABCH 140 for confirmation of a user account that matches a recipient address in the received message. If the message is determined to not be spam or UCE, and a user matches a recipient address of the message, the message is forwarded to mail store 150 where it is stored until it is deleted. Mail store 150 determines for which user the message should be stored for by accessing user information from ABCH 140.

When system 105 receives a request for a message for a user, the user's message is retrieved from mail store 150. Users having an account with a mail service provider may view their messages through web based or client based systems. For a web based mail service, a user may access mail through a browser application. For a client based system, a user may access mail through a client application. For example, when using a client-based system, a user can provide input to computing device 170 to retrieve the mail from system 105 through mail server 120. When using a web based mail service, a user can provide input to an interface provided by browser application 165 stored on and executed by computing device 160. Browser application 165 then sends a request to mail web server 110. The message information provided to the mail client or browser application in response to the message request includes safety level information as determined by the MAE when the message is initially received by system 105.

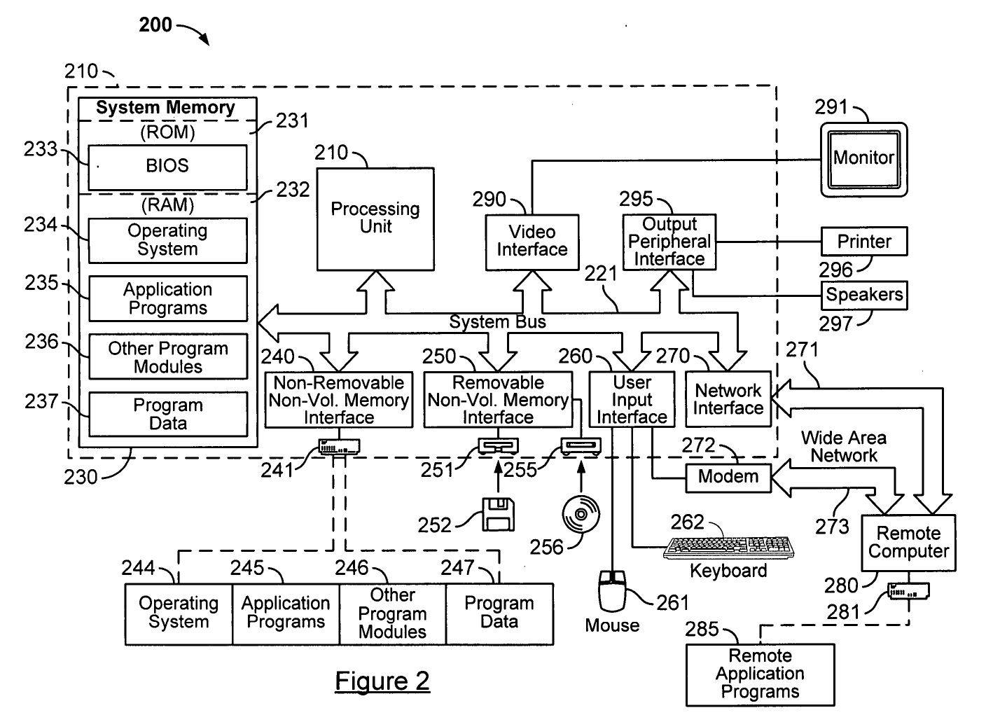

FIG. 2 illustrates an embodiment of a computing environment for implementing the present invention. In particular, computing environment 200 can be used to implement computing device 160, computing device 170, mail web server 110, mail server 120, MRA 130, SFE 135, ABCH 140, and mail store 150 of FIG. 1. Computing environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through an non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through a output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

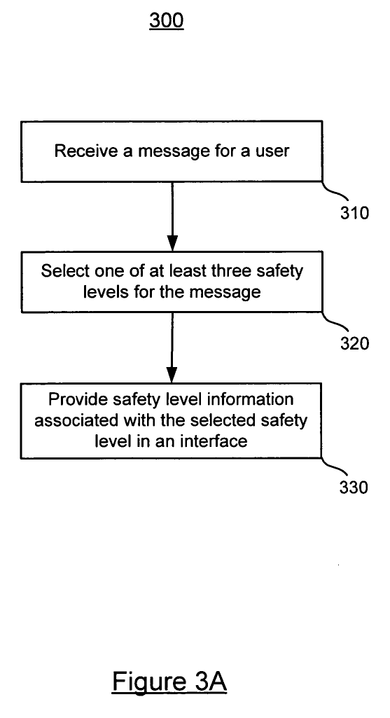

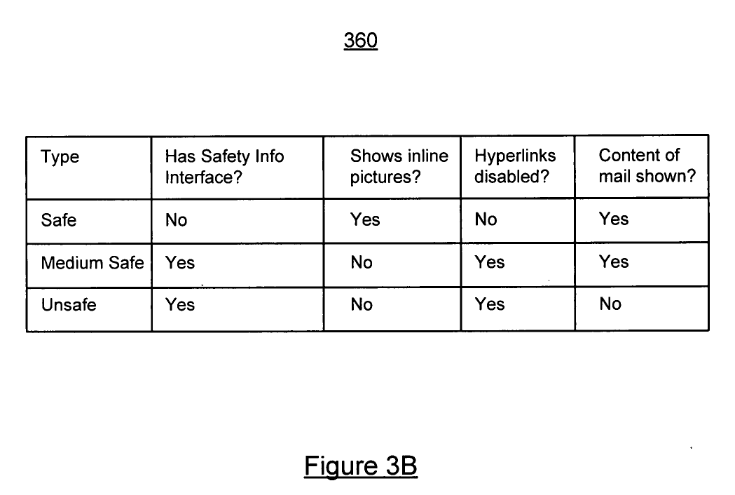

FIG. 3A illustrates an embodiment of a method for determining safety level information for a message received for a user. The message may be received by a system such as system 105 of FIG. 1. First, a message is received for a user at step 310. Next, one of at least three safety levels is selected for the message at step 320. In one embodiment, after the message is received, the message is analyzed by an MAE. The analysis of the message includes analyzing sender information, header information, message content and domain server information for the received message. Sender information may include a source address of the sender. The source address for the message can be compared to a block list and allowed senders list associated with the user. A safety level of safe may be assigned to the message if the source address of the sender matches an entry on the user's allowed senders list. Header information of the message may be used to determine whether the message is associated with a mailing list or newsletter. For example, if the message header includes unsubscribe information, the message is likely sent as part of a mailing list. In this case, an interface is provided to enable the user to unsubscribe from the mailing list.

The domain server check for a message may determine if the indicated source of the message is valid or not. For example, the source address of a message can be associated with a particular domain. The domain can be queried to determine what source addresses are allowed to send messages. If the server from which the message claims to be sent from is not a server allowed to send messages, the domain check will fail for that message. In this case, the safety level of the message will be set to unsafe. Selecting a safety level for a message is discussed in more detail below in FIG. 4.

In one embodiment, the user may be provided with the same message interface regarding safe, medium safe and unsafe messages if any of a number of other methods is used to determine message authenticity. Thus, as methods for verifying message authenticity proliferate, the messaging system described herein can be used to inform the user of such in a consistent manner. The messaging system thereby allows users to protect themselves from unsafe messages without requiring that they understand the technical details used to authenticate a particular message.

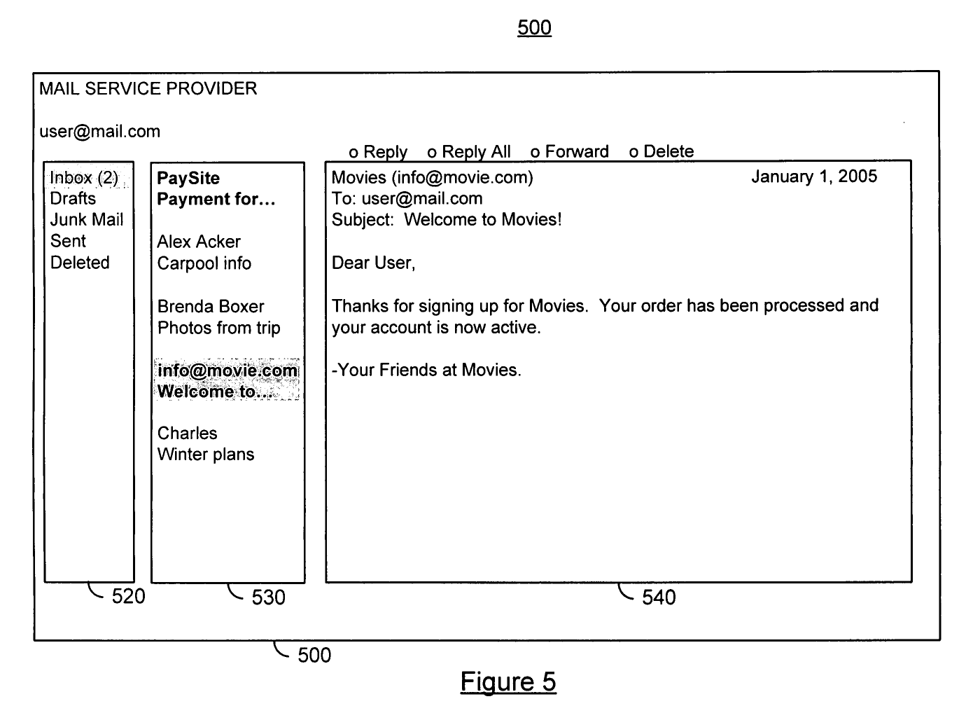

Safety level information is provided in an interface at step 330. The provided safety level information is associated with the safety level selected at step 320. The interface may be provided by a browser application or a client application. In one embodiment, the interface may include a notification if the message safety level is determined to not be safe. The notification provided in the interface may be positioned within a safety information interface. In some embodiments, if the message safety level is safe, there may be no notification or a safety level interface that indicates the user need not do anything. This is discussed in more detail below. In particular, examples of safety information interfaces are discussed in more detail with respect to FIGS. 5-8.

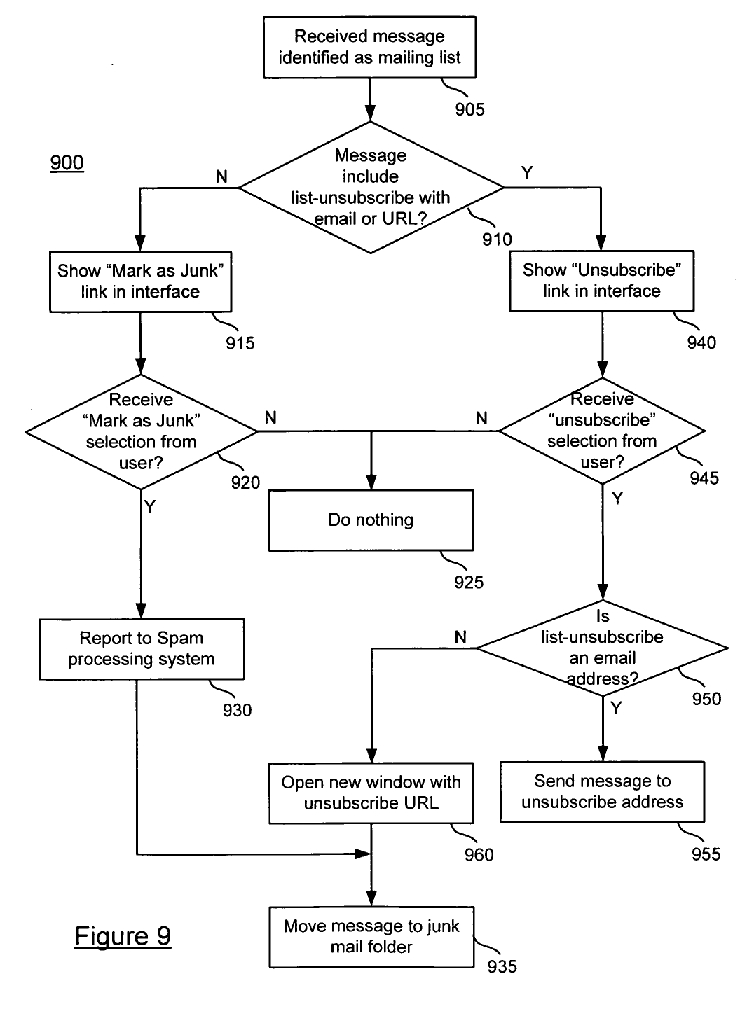

A safety information interface associated with a message may allow a user to indicate the desirability of the message. For example, the interface may include user selectable links. The links may enable a user to provide input as to whether the message should be allowed, sent to a junk folder, or some other action. If the safety level of the message has changed as a result of user input, the message can be processed accordingly. This is discussed in more detail below in FIGS. 9-14.

FIG. 3B is an example of a table having message display settings for different safety levels. Table 360 displays information for safety level type, safety information interface, inline pictures, hyperlinks, and mail content. The safety level types illustrated include safe, medium safe, and unsafe, though additional safety levels may be used. For example, additional safety levels may include unknown, a mailing list level, and a newsletter level. For the safety level types illustrated, the table illustrates, for each level, whether an application that displays a message will display a safety information interface while displaying a message. An interface will not display a safety information interface, such as a safety bar, for a safe message. Medium safe and unsafe safety level messages will be displayed with a safety information interface. Inline pictures will not be displayed for medium safe and unsafe messages. Inline pictures will be displayed for safe messages. Hyperlinks are disabled for medium safe and unsafe messages, but not disabled for safe messages. Mail content is shown for safe and medium safe messages, but not for unsafe messages. In one embodiment, the display settings of table 360 may be overruled by a user for one or more messages. For example, content for an unsafe message may not be initially displayed in the interface displaying the message, but a user may provide input to have the content displayed. Other settings may also be used to determine what is displayed to a user for different safety levels, such as animation content within a message, attachments, formatting and scripts. Table 360 is an example of one set of display settings. Other display settings may be used and are considered within the scope of the present invention.

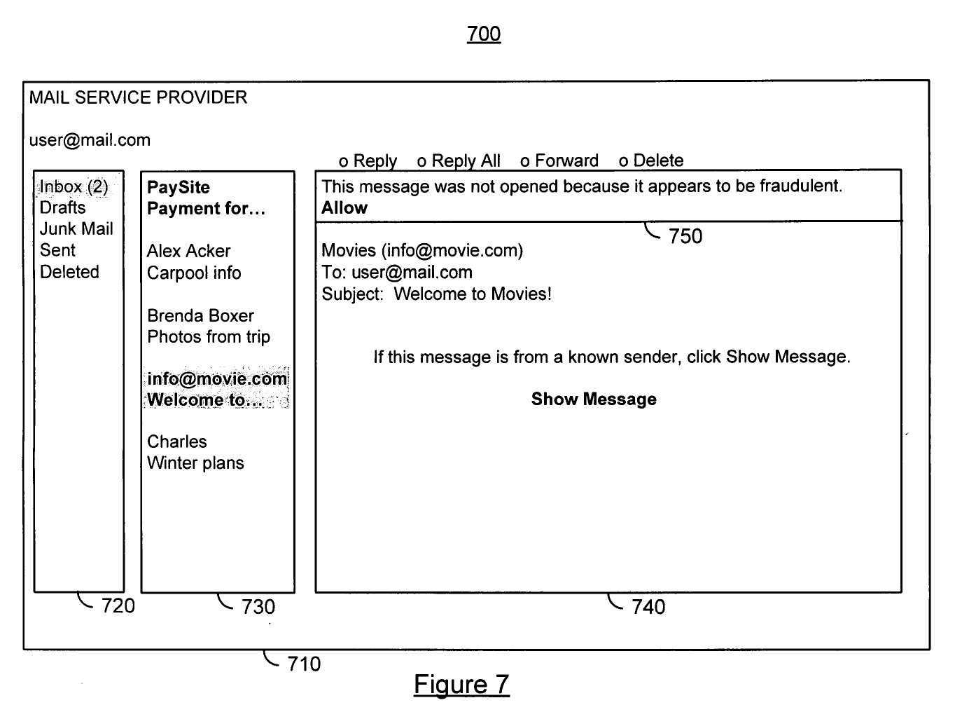

FIG. 4 illustrates an embodiment of a method 400 for determining message safety levels. In one embodiment, method 400 is performed by an MAE of system 105 of FIG. 1. The MAE may be located within mail provider system 105, computing device 160, or computing device 170. First, a new message is received for a user at step 410. The new message may be received by MRA 130 of FIG. 1. Next, a determination is made as to whether the received message is suspected to be an instance of phishing at step 415. In one embodiment, the determination as to whether a message is suspected to be phishing is made by an SFE. For example, SFE 132 or SFE 135 of FIG. 1 may make the determination. An MAE may then retrieve the results of the determination from an SFE. In another embodiment, the SFE will tag the received message with phishing information. The tag can indicate whether or not the message is suspected to be phishing. If a received message is suspected to be phishing, operation continues at step 435. If the received message is not suspected to be phishing, operation continues to step 420. At step 435, the safety level for the received message is set to unsafe. After the safety level for a message is set to unsafe, a safety level information interface is provided to a user once the user requests to view the message. Display settings of the message are applied according to table 360 of FIG. 3B. An example of an interface 700 used to display a message having a safety level of unsafe is illustrated in FIG. 7 and discussed in more detail below.

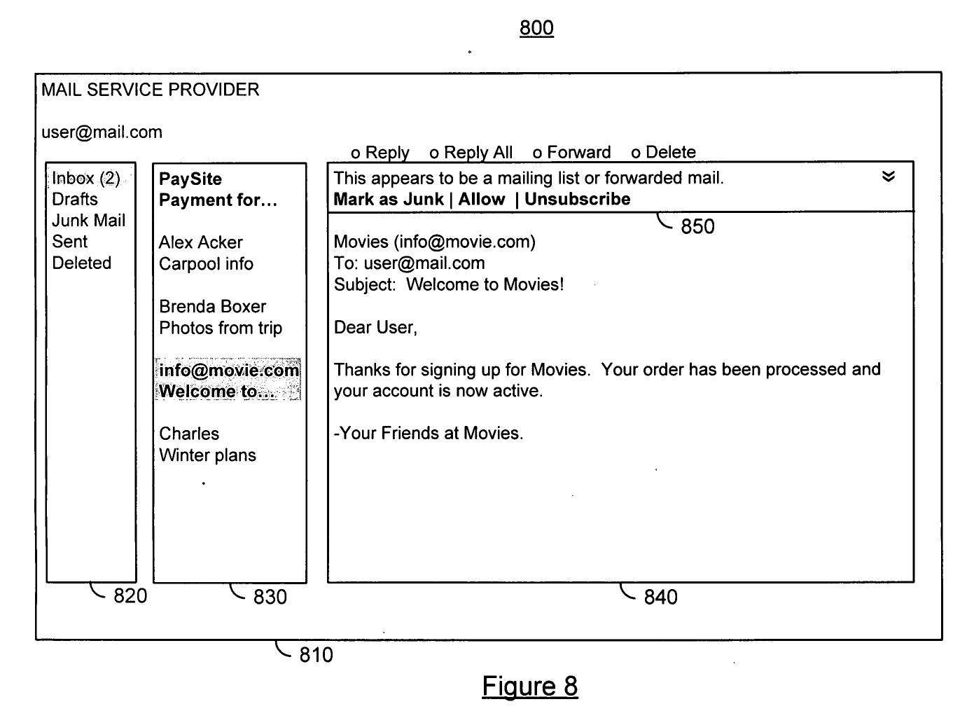

A determination is made as to whether the received message is identified as a newsletter at step 420. In one embodiment, a newsletter can be received from one of many sources. These sources include a mail service provider, a partner of the mail service provider, or some other entity. In any case, a newsletter may be used to communicate a welcome or congratulations message, a service update, a member letter or notification, or some other message to mail service users. Newsletters may be recognized by their content, header, or other data. If the received message is identified as a newsletter at step 420, operation continues at step 425. If the received message is not identified to be a newsletter, operation continues to step 430. At step 425, the message is identified as a newsletter. In one embodiment, an interface associated with the newsletter can be provided to the user. User input received through the interface can be used to determine whether or not the newsletter is desirable and should be sent to a junk folder or not. The interface displayed and additional processing performed as a result of identifying a newsletter can be similar to that for identifying a mailing list. An example of a mailing list interface is illustrated in FIG. 8 and discussed in more detail below. An example of a method for performing additional processing for a message determined to be from a mailing list is illustrated in FIG. 9 and discussed in more detail below.

A determination is made as to whether the received message failed a domain source query at step 430. In one embodiment, a domain source query determines whether the message came from a legitimate domain server. A message may indicate a domain from which it originated. For example, info@movie.com comes from the domain “movie.com” A query can be made to the domain associated with a message to determine what servers it uses to send mail. In one embodiment, a DNS check can be used to confirm if a server is allowed to send mail for a particular domain. A domain source query may return a pass, fail, or unknown result. In one embodiment, a message does not fail the domain source query if the results of the domain source query are either pass or unknown. In some embodiments, if no sender address can be determined to make the domain source query, then the query is considered failed. As discussed above, examples of domain source query services include Sender ID and DKIM. If the received message fails a domain source query at step 430, operation continues to step 435 where the safety level of the message is set to unsafe. If the message did not fail the domain source query, operation continues to step 440.

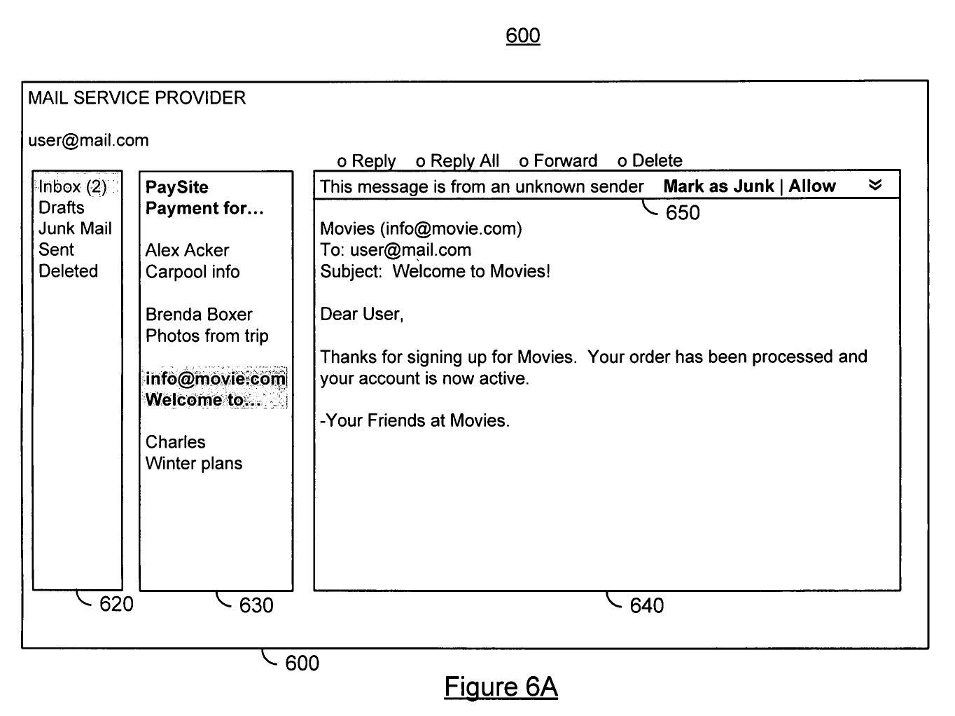

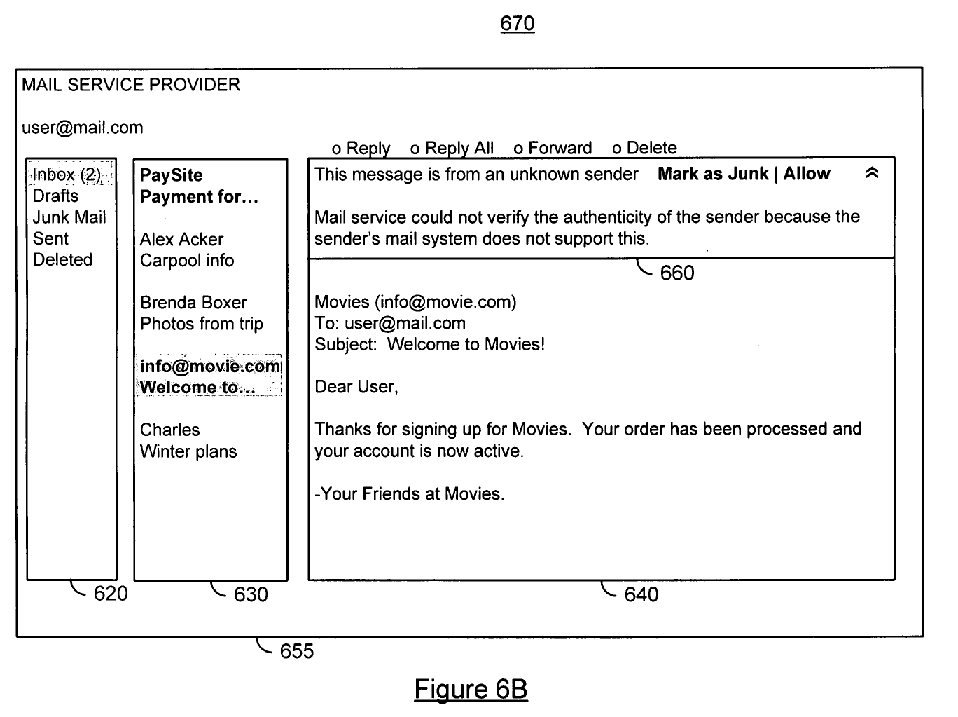

A determination is made as to whether the received message is from a known sender at step 440. A message may be from a known sender if the sender is in the user's mail contact list, instant messaging contact list, allowed senders list, or some other list associated with the user. An allowed senders list is a list of message source addresses, or senders, from which incoming messages should be accepted. Similar to a contact list, an allowed senders list may be maintained for each user having an account with a mail provider service. If the message is from a known sender, operation continues to step 445. If the message is not from a known sender, operation continues to step 450. At step 450, the safety level of the message is set to medium safe. In one embodiment, when a user requests to view a message having a safety level of medium safe, an interface is provided that incorporates the settings of table 360 of FIG. 3B. An example of an interface for a message having a safety level of medium safe is illustrated in FIGS. 6A and 6B and discussed in more detail below.

A determination is made as to whether a domain source query address is present and known at step 445. From step 430, the domain source query result at step 445 is either “unknown” or “pass.” If the address is present and known, operation continues to step 455. If the address is not present or not known, operation continues to step 450 where the safety level of the message is set to medium safe.

A determination is made as to whether two requirements are satisfied at step 455. The two requirements are that the user is not on the recipient list of the message and a sender header must be present in the received message. In one embodiment, the two requirements of step 455 determine whether or not the message is associated with a mailing list. If the two requirements at step 455 are met, operation continues at step 460. If the two requirements are not met, operation continues to step 470.

A determination is made as to whether a list unsubscribe, x-mailing list, or mailing list header is present at step 460. If an appropriate header is present at step 460, then operation continues to step 465 wherein the safety level for the message is set to safe. In one embodiment, a safety level of safe has display settings as illustrated in table 360 of FIG. 3B and may be displayed in an interface such as that provided in FIG. 5. An example of an interface for viewing a message received from a mailing list is illustrated in FIG. 9. If an appropriate header is not present at step 460, operation continues to step 470.

A determination is made as to whether the current user is in the recipient list of the message or the recipient is in an allowed mailing list of the user at step 470. If either of these conditions is found true, operation continues to step 475 wherein a junk mail mailing list toolbar is provided to a user within a user interface. If neither of these conditions is found true, operation continues to step 480 wherein a junk mail and allow sender mailing list toolbar is provided to the user. Unlike the toolbar provided at step 475, the toolbar provided at step 480 allows a user to indicate whether the message should be classified as junk as well as whether the message should be allowed.

When a received message associated with a safety level is provided for display, the message display may include information associated with the safety level. The safety level information provided in the message display may differ for each safety level. FIG. 5 illustrates an example of a mail inbox user interface for a message having a safety level of safe. Interface 500 includes folder list window 520, message list window 530, and message content window 540. Folder list 520 includes the folders inbox, drafts, junk mail, sent, and deleted. The inbox folder is currently selected as indicated by a highlight. The messages in the selected folder are displayed in message window 530. As illustrated, one message in the selected folder is highlighted. The content for the highlighted message is illustrated in message content window 540. User interface 500 also includes mail service provider information, “Mail Service Provider” and user identification information, “user@mail.com.” A number of action buttons are positioned above message content window 540. The action buttons include a reply action, reply all action, forward action, and delete action. The user interface may be implemented on a browser application in a web-based mail system such as browser application 165 of FIG. 1, or a mail client on a client-based mail system such as mail client 175 of FIG. 1. As illustrated, no safety information interface is provided in user interface 500. In this case, the safety information interface is not displayed in order to keep distractions to the user at a minimum for messages having a safety level of safe. In some embodiments, the message may be displayed with a safety level interface indicating that the message is safe. The interface may also indicate that the user does not need to take further action regarding the safety level of the displayed message.

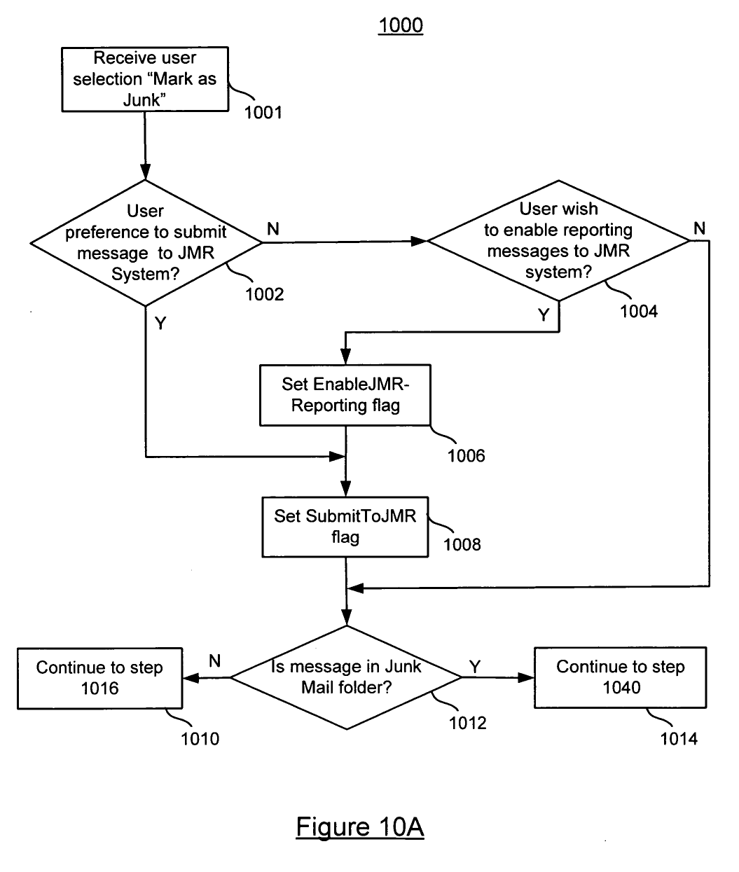

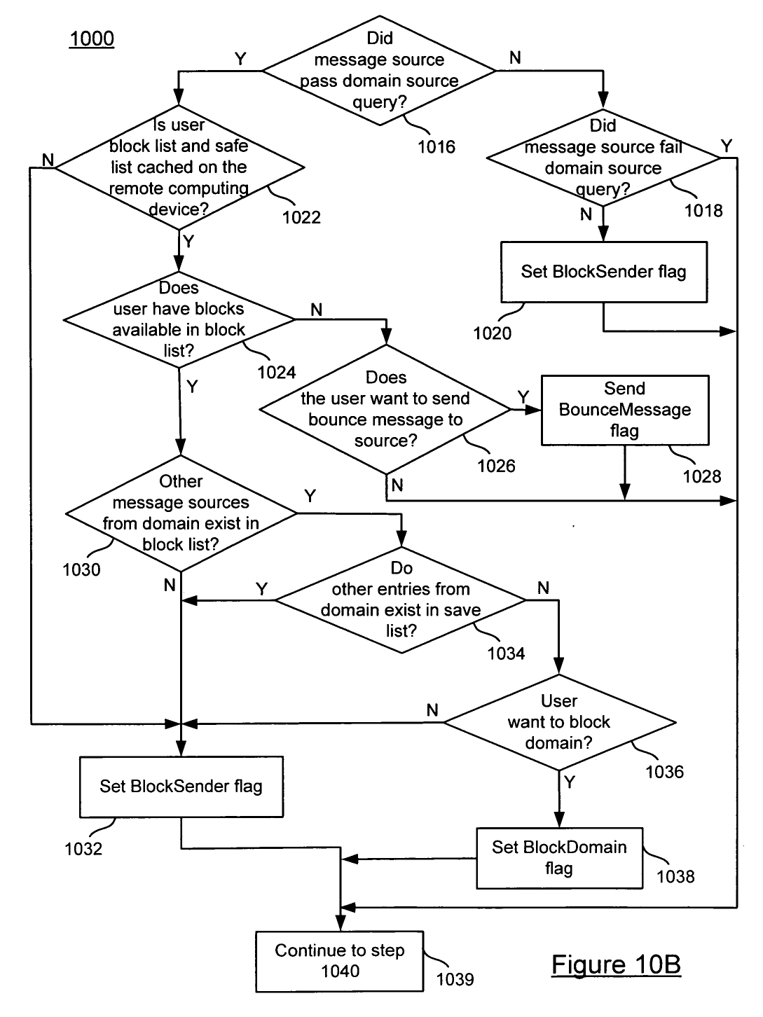

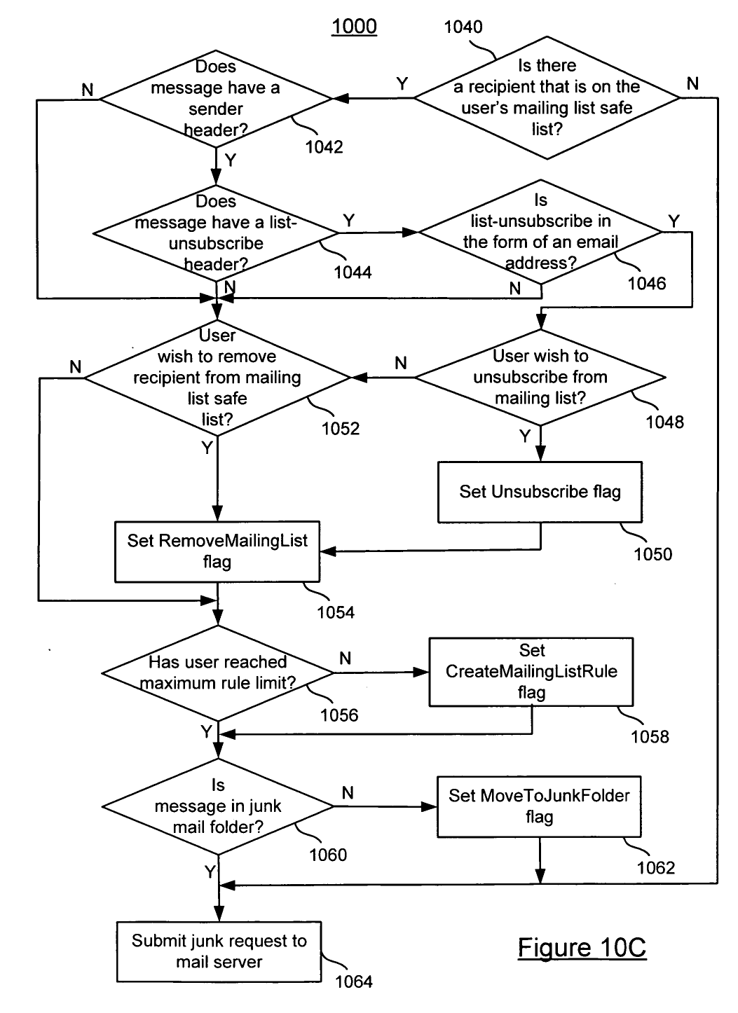

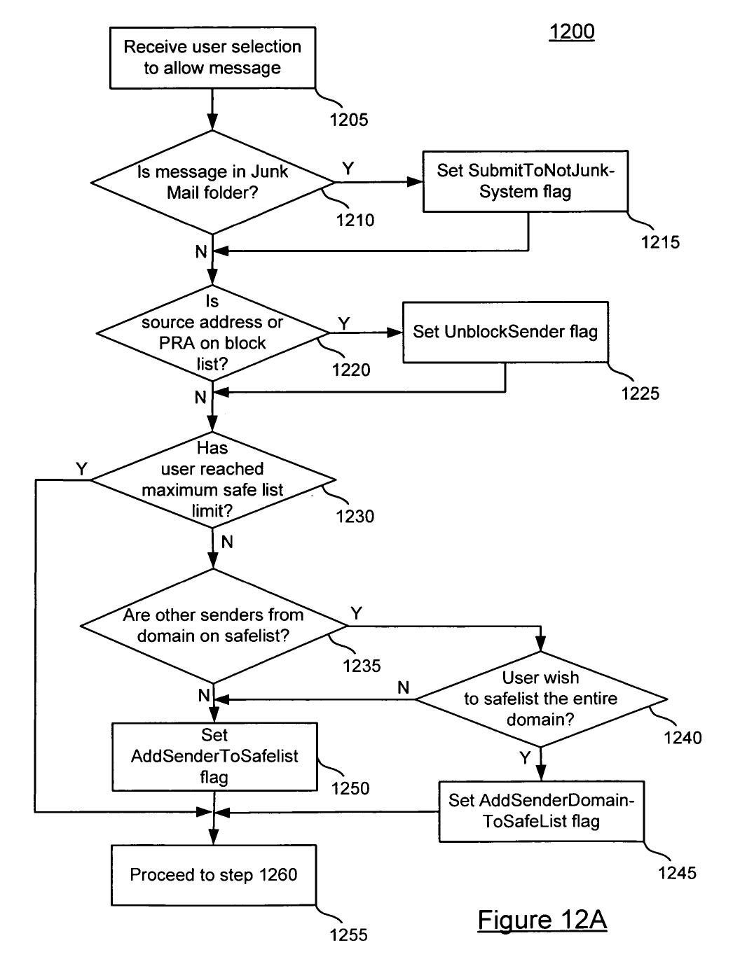

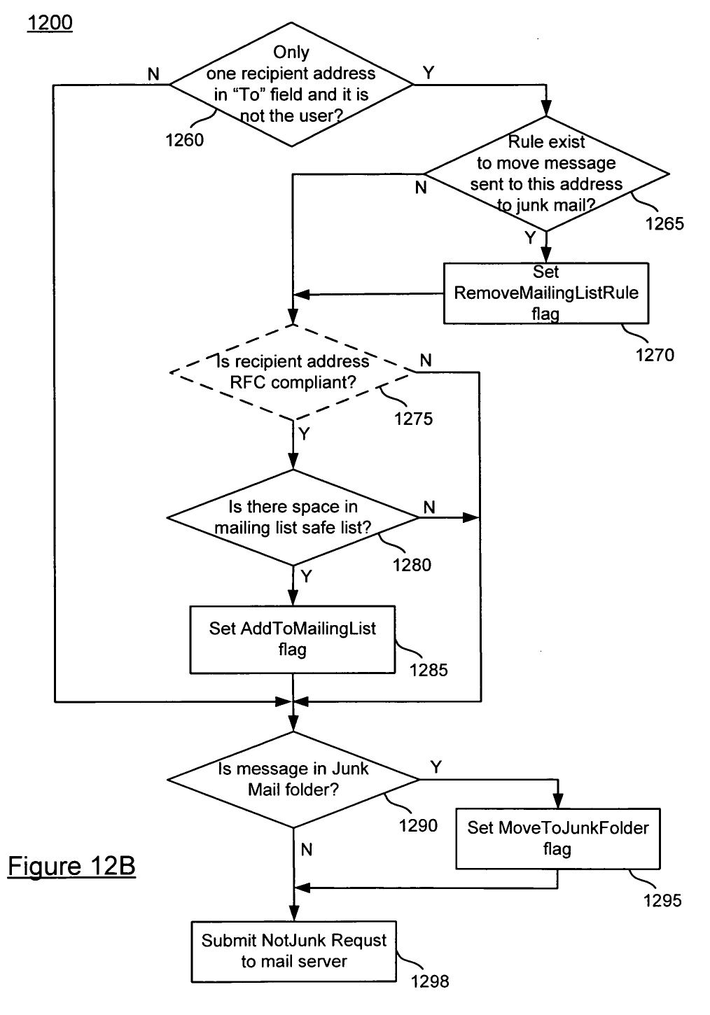

FIG. 6 illustrates an example of a mail inbox user interface for a message having a safety level of medium safe. Similar to the user interface 500 of FIG. 5, user interface 600 of FIG. 6 includes a folder list window 620, message list window 630, and a message content window 640. Message content window 640 includes safety information interface 650. The safety information interface includes a message indicating that the received message on display is from an unknown sender. Safety information interface 650 also includes links allowing a user to mark the desirability of the message. The links include a “mark as junk” link and an “allow” message link. Additionally, a chevron symbol is illustrated in the right-most portion of safety information interface 650. The chevron symbol may be used to provide more information to a user regarding the safety level of the information. In one embodiment, the chevron symbol allows users to obtain more detailed information about the cause of the safety classification. For messages having a safety level of medium safe, allowing the user to indicate whether the message is desirable helps determine a more appropriate safety level for the message. If the desirability of the message is indicated by a user, the message is processed further. Processing performed as a result of selecting a mark as junk link is described in more detail with respect to FIG. 10. Processing performed as a result of selecting an allow link are described in more detail with respect to FIG. 12A.

FIG. 6B illustrates an example of a mail inbox user interface providing additional safety level information for a message having a medium safe safety level. In particular, FIG. 6B illustrates the user interface 600 of FIG. 6 after the chevron link is selected within safety information interface 650. User interface 665 of FIG. 6B includes the windows of user interface 600 of FIG. 6A, but additional information is contained within safety information interface 660. Explanatory information is provided explaining why the received message is from an unknown sender. In particular, the message states that the mail service could not verify the authenticity of the sender because the mail system does not support this. Similar explanatory messages can be provided in response to receiving a user selection of the chevron symbol for other safety levels and other reasons for selecting a safety level.

FIG. 7 illustrates an example of a mail inbox user interface 700 for a message having a safety level of unsafe. Interface 700 includes a folder list window 720, a message list window 730, and a message content window 740. The message illustrated in interface 700 is determined to be unsafe. As a result, the message content is not displayed to the user per the display settings of table 360 of FIG. 3B. Where the content would normally be displayed, a message is displayed indicating that the content is not displayed. A link is displayed underneath the content message. If the content link is selected, the content of the message is displayed. The safety information interface 750 of user interface 700 indicates that the message was not opened because it appears to be fraudulent. An “allow” link is provided within safety information interface 750 so that a user may choose to allow the message.

FIG. 8 illustrates an example of a mail inbox user interface 800 for a message identified as being from a mailing list. A similar interface may also be displayed for a message identified as a newsletter. User interface 800 includes a folder list window 820, a message list window 830, a message content window 840, and safety information interface 850 within message content window 840. Safety information interface 850 indicates that the message appears to be from a mailing list or forwarded mail. Links are provided in the safety information interface to enable a user to indicate that the message should be allowed, sent to junk mail, or the user should be unsubscribed from the mailing list. If selection of the unsubscribe link is received, the user can be automatically unsubscribed from the mailing list. This is described in more detail with respect to FIG. 9 below.

In one embodiment, when a message received from a mailing list is displayed for a user, the safety level information of the message is displayed as well. After the message is displayed, further processing may be performed, including unsubscribing the user from the mailing list. FIG. 9 illustrates an embodiment of a method for performing processing as a result of determining a received message is from a mailing list. In one embodiment, method 900 is performed by the system of FIG. 1 in response to determining the received message is associated with a mailing list at step 460 of method 400. A received message is identified as a newsletter at step 905. Next, a determination is made as to whether list-unsubscribe information is included in the received message with an email or URL at step 910. In one embodiment, the list-unsubscribe information may be included in the header of the received message. The email and/or URL information can be used to unsubscribe the user from the mail list. If the information is contained in the message at step 910, operation continues to step 940. If the list-unsubscribe email or URL information is not contained in the message at step 910, operation continues to step 915.

In one embodiment, because spammers can add mailing list headers in order to determine if a live-person exists at that account, it is important to ensure that the unsubscribe option is only presented to users for “safe” emails. Safe emails have an added level of trust because the user has already added the sender to their mailing list and a determination has been made that the message originated from the intended source. As a result, the chances of such messages being used to nefarious ends is reduced.

A “Mark as Junk” link is displayed in a safety information interface at step 915. The link is displayed within the interface once a user requests to view the message. An “allow” link need not be displayed for the particular message because the message has already been identified as safe in method 400. An example of a “Mark as Junk” link displayed in an interface is illustrated in FIG. 8. Next, a determination is made as to whether the user has selected the Mark as Junk link at step 920. If no user selection is received, operation continues at step 925 where no further action is performed. If a “Mark as Junk” selection is received from a user at step 920, then operation continues to step 930. At step 930, the message is reported to a spam processing system. In one embodiment, the message is reported to a JRS within FIG. 1. The report or transmission indicates that the received message is undesirable. This information can be used to recognize other undesirable messages having a similar source or similar content. Operation then continues to step 935 where the received message is moved to the user's junk mail folder.

At step 940, an “Unsubscribe” link is displayed within the safety information interface for the displayed message. In one embodiment, the user selectable link allows a user to unsubscribe from the mailing list associated with the received message. An example of an interface having an unsubscribe link is illustrated in FIG. 8. Next, a determination is made as to whether an unsubscribe selection is received from a user at step 945. If an unsubscribe selection is received from a user, operation continues to step 950. If no unsubscribe selection is received from a user, operation continues to step 925 where no further action is performed.

A determination is made as to whether the list-unsubscribe information is an email address at step 950. If the list-unsubscribe information is an email address, an email is sent to the unsubscribe address at step 955. The email is sent automatically on behalf of the user and unsubscribes the user from the mailing list associated with the message. If the list unsubscribe information is not an email address, operation continues to step 960. A new interface within a browser application is opened with an unsubscribe URL at step 960. The unsubscribe URL is opened automatically on behalf of the user such that the user may indicate that he or she intends to unsubscribe from the newsletter. Unsubscribing from an email list is handled differently than unsubscribing to a URL because an email unsubscribe can positively identify the sender and unsubscribe them appropriately. Unlike using email to unsubscribe, accessing a URL to unsubscribe often lead to a separate page where the user must enter their email address before unsubscribing. Operation then continues to step 935 where the mailing list message is moved to the user junk folder.

FIGS. 6-8 illustrate interfaces for displaying a message having a safety level and corresponding safety information interface. Each safety information interface includes links that a user may select to indicate the desirability of the message. When a link is selected, the message may be processed accordingly. FIG. 10A illustrates a method for processing a message after a “Mark as Junk” link is selected in a user interface such as an interface of FIGS. 6-8. First, a user selection of a “Mark as Junk” link is received at step 1001. The selection may be received by computing device 160 or computing device 170, depending on the mail system used. Next, a determination is made as to whether a user has made a preference to submit messages to a junk mail reporting system at step 1002. In one embodiment, the system of the present invention determines whether the user has previously indicated to inform a junk mail reporting (JMR) system of the messages sent to the user's junk mail folder. If a user preference to submit messages to a JMR system is determined, operation continues to step 1008. If the user preference is to not submit messages to a JMR system, operation continues to step 1004.

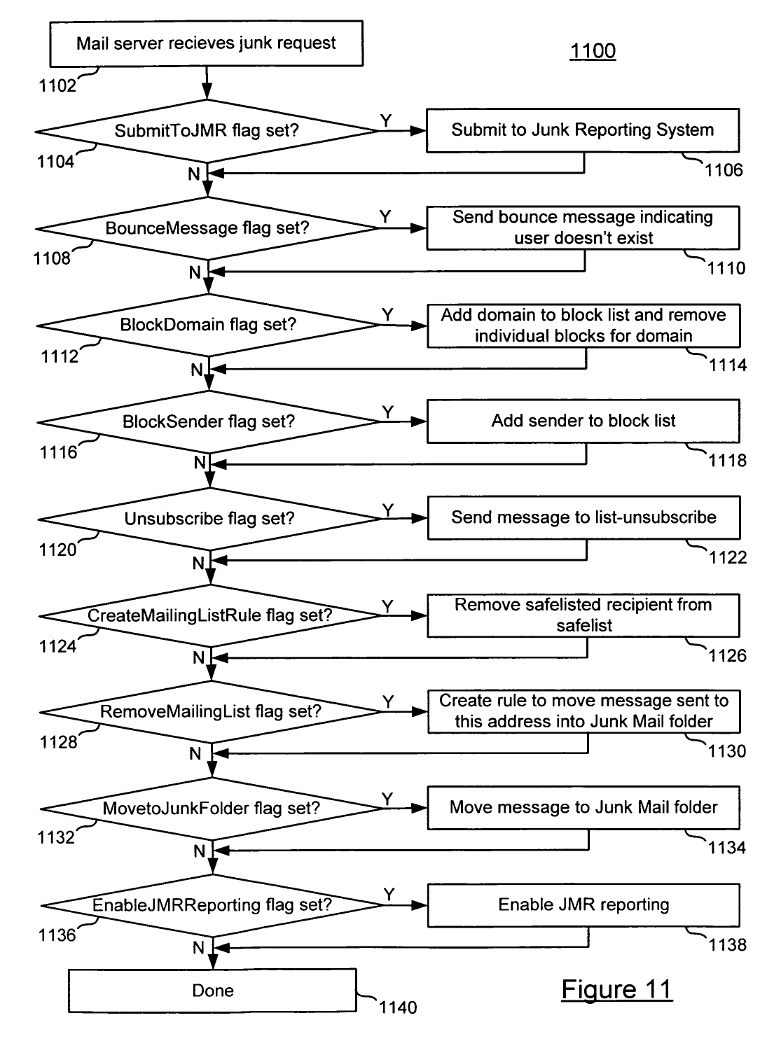

The user is queried as to whether to enable reporting messages to a JMR system at step 1004. If the user response enables reporting messages to a JMR system, operation continues to 1006. If the user response indicates that the user does not wish to enable reporting to a JMR system, operation continues to step 1012. An EnableJMR reporting flag is set at step 1006. The setting of this flag indicates that JMR reporting should be enabled. Processing of flag settings in response to selection of a “Mark as Junk” link is discussed in more detail below with respect to FIG. 11. Next, a SubmitToJMR flag is set at step 1008. Setting this flag indicates the message should be submitted to the JMR system. Next, a determination is made as to whether the received message is currently in the user's junk mail folder at step 1014. At step 1014, operation of method 1000 continues to step 1040 in FIG. 10C. If the message is currently in the user's junk mail folder, then operation of method 1000 continues at step 1040. If the message is not currently in the user's junk mail folder, then operation of method 1000 continues to step 1010. At step 1010, operation of method 1000 continues to step 1016 in FIG. 10B.

FIG. 10B illustrates a continuation of an embodiment of a method for processing a message after “Mark as Junk” is selected in a user interface such as that of FIGS. 6-8. A determination is made as to whether the message source of the received message passed a domain source query at step 1016. In one embodiment, the domain source query is performed at step 430 of method 400. If the received message source passed the domain source query, operation continues to step 1022. If the message source did not pass the domain source query, operation continues to step 1018. A determination is made as to whether a block list and allowed senders list associated with the user who received the message is cached on the remote computing device accessing the message at step 1022. In one embodiment, a block list and allowed senders list can be cached in memory of the computing device on which the browser application or client application is stored and/or executed. If both the block list and allowed senders list are cached on the computing device, operation continues at step 1024. If the block list and allowed senders list are not both cached on the computing device, then operation continues at step 1032.

A flag is set indicating that the source address of the received message is to be added to the user's BlockSender list at step 1032. In one embodiment, rather than setting a flag at step 1032, the sender address is immediately added to the user's BlockSender list. In some embodiments, before the BlockSender flag is set or before the source address is added to the BlockSender list, a determination is made as to whether the sender of the email is legitimate. Making this determination before adding a sender to the user's block list prevents adding a false source address to the block list, which can have a limited number of entries. For example, the determination may begin with performing a DNS query to determine if the source of the message can receive email. The query may be placed to a remote DNS server or some other source. The query results in receiving information regarding whether or not the server associated with the message source may received electronic messages. If the server can not receive electronic messages, the source address should not be added to the block list because it is not a valid source. In this case, the source address was likely chosen by an illegitimate message sender and will not likely be used again as often as a legitimate source address that sends unwanted messages.

A determination is made as to whether a user has block entries available in the user's block list at step 1024. In one embodiment, each user is associated with a block list. The block list includes entries consisting of senders of messages. A message sent to a user from a sender listed in a user's block list will be “blocked” and not delivered to the user. If the user has blocks available in the user's block list, operation continues at step 1030. If the user does not have blocks available in the block list, operation continues to step 1026.

The system of the present invention determines whether other mail sources from the domain exist from the user's block list at step 1030. This determination is performed to enquire whether the user may wish to block subsequent messages from all senders associated with the domain of the received message. For example, a currently received message may be from a sender such as info@movie.com. A block list entry may consist of newsletter@movie.com, having the same domain (movie) as the received message. In this case, another mail source from the domain exists in the block list. If other mail sources from the domain exist in the block list, operation continues to step 1034. If other mail sources from the domain do not exist from the block list, operation continues to step 1032.

Entries from the domain of the received message may also exist in the user's save list. A determination is made as to whether other entries from the domain exist in a user's save list at step 1034. A save list contains a number of entries similar to that of a user's block list. However, the entries of a save list consist of sender addresses from which messages should be saved rather than deleted. If entries from the domain of the received message exist in the user's save list, operation continues to step 1032. In this case, the particular sender will be blocked but the entire domain should not be blocked. If no other entries from the domain of the received message exist in the save list and the domain is not in the “KnownDomain” list, operation continues to step 1036. The “KnownDomain” list is a list of mail domains that are not to be entirely allowed or blocked. Examples include hotmail.com, yahoo.com, etc. If the user allows this domain it would open them up to a lot of senders some of whom may be spammers and scammers; similarly if they block these domains they may be blocking many emails that they actually wish to receive.

Since the user contains an entry in their block list from the domain of the received message, but not in their save list, the user may wish to block all messages form the domain. A determination is made as to whether a user wishes to block the domain of the received message at step 1036. In one embodiment, a query is made to make this determination. If at step 1036 a user indicates that the domain should be blocked, operation continues to step 1038. If the user indicates the domain should not be blocked, operation continues to step 1032. At step 1032, a block sender flag is set. In another embodiment, rather than setting a flag, the sender's address is immediately added to the user's BlockSender list. This indicates that the sender of the currently received message should be blocked. Operation then continues to step 1040. At step 1038, a block domain flag is set. This flag indicates that all subsequent messages received from the domain associated with the received message should be blocked. Operation then continues to step 1039. In another embodiment, rather than setting a flag, the sender's address is immediately added to the user's BlockSender list. At step 1039, operation of method 1000 continues to step 1040 in FIG. 10C.

At step 1026, a determination is made as to whether the user wishes to send a bounce message to the source of the received message. In one embodiment, a user is queried to make this determination. Sending a Non-Delivered Report (NDR) (a.k.a. bounce message) to the source will simulate the message sent to a sender indicating that the intended recipient of the message does not exist. This technique is useful for mailing lists that consciously unsubscribe recipients who do not exist. Some of these mailing lists also have unsubscribe links in the content of their email, but many cautious email users do not click on links of unwanted email for fear of identifying themselves as a live body to spammers. If the user indicates that a bounce message should be sent to the source of the received message at step 1026, operation continues to step 1028. If the user indicates that a bounce message should not be sent to the source, operation continues to step 1039. At step 1028, a bounce message flag is set. The setting of this flag indicates a bounce message should be sent to the sender of the received message. Operation then continues to step 1039.

At step 1018, a determination is made as to whether the message source failed the domain source query. As discussed above, results of a domain source query are determined in method 400 and may include pass, fail, or unknown. If the message source failed the domain source query, operation continues to step 1039. If the message source did not fail the domain source query, operation continues to step 1020 where a block sender flag is set. In another embodiment, if few domains fall into an unknown state, the block sender flag may not be set if the message source does not fail the domain source query. Operation then continues to step 1039.

FIG. 10C illustrates a continuation of an embodiment of a method for processing a message after mark as junk is selected in a user interface, such as that of FIGS. 6-8. A determination is made at step 1040 as to whether there is a recipient of the received message that is on the user's mailing list allowed senders list. If any of the recipient addresses of the received message are located on the user's mailing list allowed senders list, operation continues to step 1042. If no recipients of the received message exist on the user's mailing list allowed senders list, operation continues to step 1064. A determination is made as to whether the mail has a sender header at step 1042. This determination involves whether the sender is identified in the header portion of the received message. If the sender is not in the header of the message, operation continues to step 1052. If the message does have a sender header, then operation continues to step 1044. At step 1044, a determination is made as to whether the received message has a list-unsubscribe header. A list-unsubscribe header is used to indicate that the message is associated with a newsletter or mailing list that the user subscribes to. If the received message does not have a list-unsubscribe header, operation continues to step 1052. If the received message does have a list-unsubscribe header, then operation continues to step 1046.

At this point in method 1000, the received message has been identified as undesirable by a user and from a mailing list. The user may wish to unsubscribe from the mailing list. A determination is made as to whether the list-unsubscribe information in the received message is in the form of an email address at step 1046. If the list-unsubscribe information includes an email address, then operation continues from step 1046 to step 1048. If the list-unsubscribe information in the received message is not in the form of an email address, operation continues to step 1052. At step 1052, a determination is made as to whether the user wishes to remove the recipient from the mailing list allowed senders list. In this case, in addition to having an allowed senders list for individual sender entities, a user may have an allowed senders list for mailing lists as well. In one embodiment, a system may query a user to determine whether to remove the recipient from the mailing list allowed senders list. If the recipient address should be removed form the mailing list allowed senders list at step 1052, operation continues to step 1054. If the address should not be removed from the mailing list allowed senders list, operation continues to step 1056.

A determination is made as to whether a user wishes to unsubscribe from a mailing list associated with the received message at step 1048. In one embodiment, the user may be queried to make this determination. If it is determined that the user wishes to unsubscribe from the mailing list associated with the received message at step 1048, operation continues to step 1050. At step 1050, an unsubscribe flag is set that indicates the user should be unsubscribed from the mailing list. After setting the Unsubscribe flag at step 1050, operation continues to step 1054. If the user does not wish to unsubscribe from the mailing list, operation continues to step 1052.

A RemoveMailingList flag is set at step 1054 indicating the user should be removed from this mailing list associated with the received message. Operation then continues to step 1056. A determination is made as to whether the user has reached a maximum rule limit at step 1056. In one embodiment, each user has a maximum number of rules they may associate with their account. If the user has not yet achieved the maximum number of rules for their account, then operation continues from step 1056 to step 1058. At step 1058, a CreateMailingListRule flag is set. This flag generates a new rule removing the recipient address from the allowed senders list. Operation then continues to step 1060. If at step 1056 the user has reached the maximum rule limit, operation continues to step 1060.

Since the user indicated the received message is not desired, the message should be placed in the user's junk folder if it is not already there. In another embodiment, the message may just be deleted from the system. A determination is made as to whether the received message is currently located in the user's junk mail folder at step 1060. If the message is currently located in the user's junk mail folder, operation continues to step 1064. If the message is not currently located in the user's junk mail folder, then operation continues to step 1062 where a MoveToJunkFolder flag is set. Setting this flag indicates the message should be moved to the user's junk folder. Operation then continues to step 1064. At step 1064 a junk request is submitted to a mail server. The junk request is generated in response to receiving input from a user indicating a message is undesirable. The request contains data and/or information that the receiving mail server can use to process the received message. Junk request data may also be used to adjust user preferences for processing subsequently received messages. In the case of a client application, for example, mail client 175 of FIG. 1, the submit junk request is submitted to mail server 120. In the case of a browser application, for example browser application 165 of FIG. 1, the junk request is submitted to mail web server 110.

FIG. 11 illustrates an embodiment of a method for processing a junk request received by a mail server. The junk request is sent to the mail server by a browser application or client application, depending on the system a user is accessing mail with. The mail server receiving the junk request processes information contained in the request. The information included in the junk request may include several flag settings. Upon determining the settings of the flags in the junk request, the mail server may perform a task on the message (such as move the message to a different folder in the user's account), generate a rule, or make an addition or a deletion of an entry to a list associated with the user's mail account. FIG. 11 illustrates examples of flags that can be processed by a mail server which were set in method 100 by an application executed by a computing device. The flags settings discussed in method 1100 are examples of possible flag settings. Other processing based on flag settings or other information received in a junk request can be performed and are considered within the scope of the present invention.

A mail server receives the junk request at step 1102. The junk request may be received from a browser application, mail client, or some other application from a remote computing device. A determination is made at step 1104 as to whether the SubmitToJMR flag is set. If the submit to JMR flag is set at step 1104 the received message for the user is submitted to the JRS at step 1106. In one embodiment, the message may be sent to a JRS within FIG. 1, including JRS 113 of mail web server 110, JRS 123 of mail server 120, and JRS 137 of SFE 135. Operation then continues at step 1108. If the submit to JMR flag is not set at step 1104, operation continues to step 1108.

A mail server may cause the received message to be bounced as a result of a user request received in method 1000. A determination is made as to whether the BounceMessage flag is set at step 1108. If the BounceMessage flag is not set, operation continues to step 1112. If the BounceMessage flag is set, operation continues to step 1110. A bounce message is sent indicating that the recipient address for the received message does not exist at step 1110. The bounced message is sent in response to receiving the received message for the user and indicates that the recipient address of the message is not valid. In one embodiment, MRA 130 can send the bounce message to the source of the received message. Operation then continues to step 1112.

All messages received from a domain should be blocked if the user indicated this preference at step 1038 of method 1000. A determination is made as to whether a BlockDomain flag is set at step 1112. If the BlockDomain flag is not set, operation continues to step 1116. If the BlockDomain flag is set at step 1112, operation continues to step 1114. The domain associated with the received message is added to the block list of the user at step 1114. Additionally, individual blocks for the domain that currently exist on the user's block list are removed. This serves to remove redundant block entries in the user's block list. As a result of adding the domain associated with the received message to the user's block list, subsequent messages received from a sender associated with the domain will not be accepted by the mail service provider. Operation then continues from step 1114 to step 1116.

Subsequent messages received from a sender which the user wishes to add to her block list in method 1000 should not be accepted. A determination is made as to whether a BlockSender flag is set at step 1116. If the BlockSender flag is not set, operation continues to step 1120. If the BlockSender flag is set at step 1116, operation continues to step 1118. The sender is added to the user's block list at step 1118. This serves to block subsequent messages received from the sender of the received message. In one embodiment, the block list may be maintained by a mail receiving agent, such as MRA 130 of FIG. 1. Operation then continues to step 1120.

If the Unsubscribe flag was set at step 1050 of method 1000, the user should be unsubscribed from the mailing list associated with the received message. A determination is made as to whether the Unsubscribe flag is set at step 1120 of method 1100. If the Unsubscribe flag is not set, then operation continues to step 1124. If the Unsubscribe flag is set at step 1120, operation continues to step 1122. A mail is sent to the list-unsubscribe address associated with the received message at step 1122. In one embodiment, the message is sent by a mail transfer agent, or MTA (not illustrated in FIG. 1). The message sent to the list-unsubscribe address will result in unsubscribing the user from the mailing list associated with the received message. Operation then continues to step 1124.

If the user indicated that a recipient address be removed from the user's allowed senders list, the user indication can be carried out using a CreateMailingListRule flag. A determination is made as to whether a CreateMailingListRule flag is set at step 1124. If the CreateMailingListRule flag is not set, operation continues to step 1128. If the CreateMailingListRule flag is set, operation continues to step 1126. The recipient address listed in the received message is removed from the user's allowed senders list at step 1126. Subsequent received messages having the indicated recipient address will not be automatically saved. Operation then continues to step 1128.

The recipient address of the received message may be removed from the user's mailing list allowed senders list if indicated by the user at step 1052 of method 1000. A determination is made as to whether the RemoveMailingList flag is set at step 1128. If the RemoveMailingList flag is not set at step 1128, operation continues to step 1132. If the RemoveMailingList flag is set at step 1128, operation continues to step 1130. A rule is created to move mail sent to the recipient specified in the received message to the junk mail folder at step 1130. Once this rule is generated, subsequent messages addressed to this recipient, such as a newsletter or mailing list recipient address, will be placed in the user's junk mail folder. This rule may be implemented in a mail store, such as mail store 150 of FIG. 1. Operation then continues to step 1132.

A determination is made as to whether a MoveToJunkFolder flag is set at step 1132. If a MoveToJunkFolder flag is not set, operation continues to step 1136. If a MoveToJunkFolder flag is set at step 1132, operation continues to step 1134. The received message is moved to the user's junk mail folder at step 1134. Operation then continues to step 1136.

JMR reporting enables junk mail messages to be reported to the junk mail reporting system. A JMR system may be maintained by a system administrator (not illustrated in FIG. 1). In one embodiment, the receiving mail server can check a flag to determine if JMR reporting should be enabled. A determination is made as to whether an EnableJMRReporting flag is set at step 1136. If the EnableJMRReporting flag is not set, then operation continues to step 1140 where the processing of the junk request by the mail server is complete. If the EnableJMRReporting flag is set at step 1136, JMR reporting is enabled at step 1138. Operation then of method 1100 then ends at step 1140.

As mentioned above, FIGS. 6-8 illustrate interfaces for displaying a message having a safety level and corresponding safety information interface. Each safety information interface includes links that a user may select to indicate the desirability of the message. When a link is selected, the message may be processed accordingly. FIG. 12A illustrates an embodiment of a method for processing a message after “allow” is selected in the user interface, such as a user interface of FIGS. 6-8. A user selection to allow a received message is received at step 1205. The user selection may be received through an interface containing an allow link such as a safety information interface of FIGS. 5-8. Next, a determination is made as to whether the received message is located in a junk mail folder of the user at step 1210. If the received message is currently located in the user's junk mail folder, operation continues to step 1215. If the received message is not currently located in the user's junk mail folder, operation continues to step 1220. At step 1215, a SubmitToNotJunkSystem flag is set. Setting this flag indicates the message should be transferred from the junk mail folder to the user's inbox folder. Operation then continues to step 1220.

A determination is made as to whether the source address of the received message is on the user's block list at step 1220. If the source address is located on the user's block list, operation continues to step 1225. If the source address is located on the user's block list, operation continues to step 1230. An UnblockSender flag is set at step 1225. Setting the UnblockSender flag indicates the sender should be removed from the user's block list. Operation then continues from step 1225 to step 1230.

Since the user has indicated the received message is desirable, the sender of the message can be added to the user's allowed senders list if it has not reached its full capacity. A determination is made as to whether the user has reached a maximum allowed senders list limit at step 1230. If the allowed senders list associated with the user does not have the maximum number of entries, operation continues to step 1235. If the user's allowed senders list is full and no further entries may be added, operation continues to step 1255. At step 1235, a determination is made as to whether other senders from the domain of the received message are located on the user's allowed senders list in case the entire domain should be added. If other senders from the domain of the received message are listed on the user's allowed senders list, operation continues to step 1240. If other senders from the domain are not on the user's allowed senders list, operation continues to step 1250.

At step 1250, a determination is made as whether the user wishes to add the entire domain associated with the received message to the allowed senders list. In one embodiment, the user is queried to make this determination. If the user indicates that the entire domain associated with the received message should be added to an allowed senders list, operation continues to step 1245. If the user indicates that the entire domain associated with the received message should not be added to the allowed senders list, operation continues to step 1250.

In one embodiment, before the query is made, a check may be performed to determine if the domain is in the KnownDomain list. If so, the user will not be allowed to safelist the entire domain. This prevents a user from safelisting an entire domain when they likely intended to merely receive mail from a handful of users from that domain.

At step 1250, an AddSenderToSafeList flag is set. The AddSenderToSafeList flag causes the sender of the received message to be added to the allowed senders list. Operation then continues to step 1255. At step 1245, an AddSenderDomainToSafeList flag is set. This causes the domain associated with the received message to be added to the allowed senders list of the user. Operation then continues to step 1255. At step 1255, operation of method 1200 continues at step 1260 of FIG. 12B.

FIG. 12B illustrates a continuation of method 1200 for processing a message after “allow” has been selected on a user interface. At step 1260, a determination is made as to whether the received message has only one recipient address and that the recipient address is not the user. This determination is used to help determine whether the received message is part of a mailing list or newsletter. If there's only one recipient in the To field and the one recipient address is not the user, operation continues to step 1265. If there is more than one recipient or the user is listed as the recipient for the received message, operation continues to step 1290.

If operation continues to step 1265 in method 1200, then the received message is determined to be from a mailing list. A determination is made as to whether a rule exists to move mail sent to the recipient address of the received message to the user's junk mail folder at step 1265. If such a rule exists, the rule needs to be removed. If the rule does exist at step 1265, operation continues to step 1270. If the rule does not exist, operation continues to step 1275. At step 1270, a remove mailing list rule flag is set. The setting of this flag will indicate the mailing list rule should be removed by a mail server. Operation then continues to step 1275.

A determination is made as to whether the recipient address is RFC compliant at step 1275. An RFC compliant address is one that meets requirements for the email protocols defined in the RFC documents (specifically 2821 and 2822) published by the Internet Engineering Task Force, IETF. In one embodiment, step 1275 is optional. If the recipient address is RFC compliant, operation continues to step 1280. If the recipient address is not RFC compliant, operation continues to step 1290. A determination is made at step 1280 as to whether space in the mailing list allowed senders list exists. If there is space in the mailing list allowed senders list at step 1280, then operation continues to step 1285. If there is no space in the mailing list allowed senders list, operation continues to step 1290. An AddToMailingList flag is set at step 1285. The setting of this flag indicates the mailing list address should be added to the user's mail list allowed senders list by a mail server. Operation then continues to step 1290.

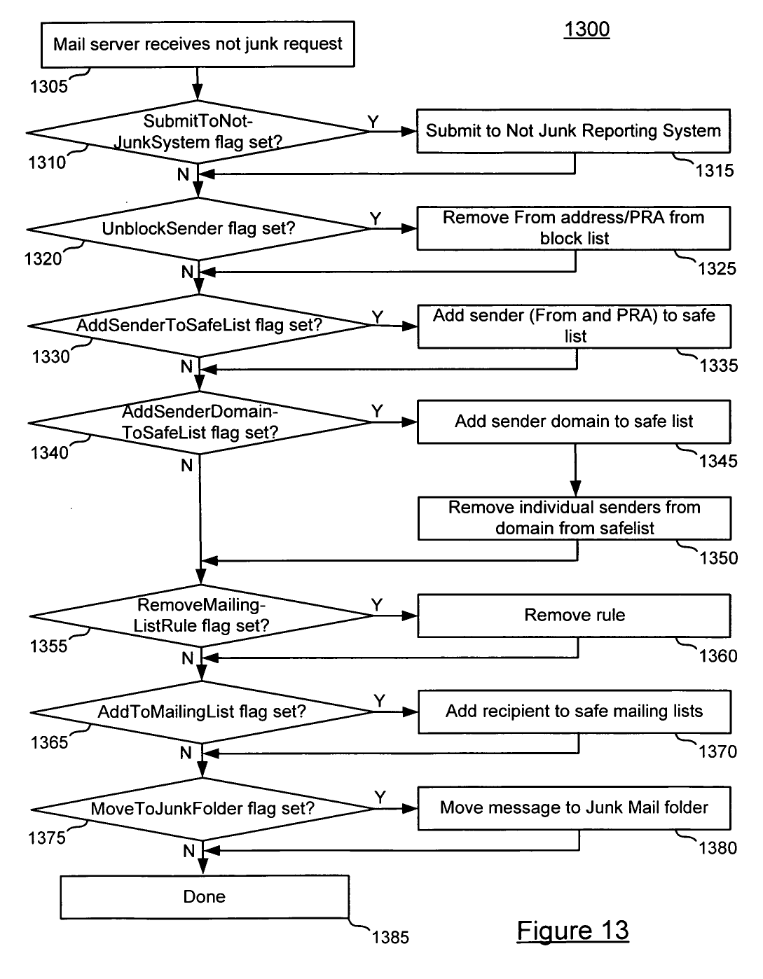

Since the user indicated the received message is desirable, it should not be stored in the user's junk folder. A determination is made as to whether the received message is currently located in the user's junk mail folder at step 1290. If the message is currently located in the user's junk mail folder, operation continues to step 1295 where a MoveToJunkFolder flag is set. In one embodiment, the MoveToJunkFolder flag is set to false indicating that the message should not be moved to the junk folder, but rather moved out of the user's junk folder. In another embodiment, a flag separate from the MoveToJunkFolder flag may be used to move the received message out of the junk mail folder, for example, a MoveToInboxFolder flag. Operation continues from step 1295 to step 1298. At step 1298, a not junk request is submitted to a mail server. The not junk request is generated in response to receiving input from a user indicating a message is desirable. The request contains data and/or information that the receiving mail server can use to process the received message. Not junk request data may also be used to adjust user preferences for processing subsequently received messages. In a mail web service system, the not junk request is sent from computing device 160 to mail web server 110. In a client application email system, the not junk request is sent from computing device 170 to mail server 120. Processing of the not junk request by the particular mail server is described below with respect to FIG. 13.

FIG. 13 illustrates an embodiment of a method for processing a non-junk request received by a mail server. The not junk request is received from an application residing on a remote computing device. The mail server receiving the non junk request processes data and/or information contained in the request. The information included in the not junk request may include several flags. Upon determining the settings of the flags in the not junk request, the mail server may perform a task on the message (such as move the message to a different folder in the user's account), generate a rule, or make an addition or a deletion of an entry to a list associated with the user's mail account. FIG. 13 illustrates examples of flags that can be processed by a mail server which were set in method 1200 by an application executed by a computing device. The flags settings discussed in method 1300 are examples of possible flag settings. Other processing based on flag settings or other information received in a non junk request can be performed and are considered within the scope of the present invention.

A mail server receives the not junk request at step 1305. In the case of a browser application, a mail web server, such as mail web server 110 of FIG. 1, may receive the not junk request. In the case of a mail client sending the not junk request, a mail server, such as mail server 120 of FIG. 1, may receive the not junk request. Next, a determination is made as to whether a SubmitToNotJunkSystem flag is set at step 1310. If the SubmitTo-NotJunkSystem flag is not set, operation continues at step 1320. If the SubmitToNotJunkSystem flag is set, then operation continues at step 1315. The receiving message is submitted to an NJRS at step 1315. The appropriate NJRS will place the received message in the user's inbox. An NJRS such as NJRS 112, NJRS 122, or NJRS 136 of FIG. 1 may move the message. Operation then continues to step 1330.

If a user indicated that a sender should be added to their allowed senders list in method 1200, the mail server processing the not junk request may process the user's request. A determination is made as to whether an AddSenderToSafeList flag is set at step 1330. If an AddSenderToSafeList flag is not set, operation continues to step 1340. If the AddSenderToSafeList flag is set, operation continues to step 1335. The sender is added to the user's allowed senders list at step 1335. Adding the sender of the received message to the allowed senders list allows messages to be saved and not be placed in the user's junk mail folder. The allowed senders list may be maintained by MRA 130, mail store 150, SFE 135, mail server 120, and web server 110, or ABCH 140 of system 105. Operation then continues to step 1340.

If a user indicated that the domain associated with a received message should be added to their allowed senders list in method 1200, the mail server processing the not junk request may process the user's request. A determination is made as to whether an AddSenderDomainToSafeList flag is set at step 1340. If an AddSenderDomainToSafeList flag is set, operation continues to step 1345. If the AddSenderDomainToSafeList flag is not set, operation continues to step 1355. At step 1345, the sender domain is added to the user's allowed senders list. In this case, all subsequent messages received from a sender address associated with this domain added to the allowed senders list will be received by the user and subsequently placed in the user's inbox. Next, individual senders in the domain associated with the received message are removed from the user's allowed senders list at step 1350. Removing the individual allowed sender list entries prevents unneeded allowed senders list entries from being stored in the user's allowed senders list. Operation then continues to step 1355.

A determination may have been made in method 1200 to remove a rule that sends messages from particular sender to the user's junk folder. This rule may be removed if the user indicated a particular message from the sender is desirable. A determination is made as to whether a RemoveMailingListRule flag is set step 1355. If the RemoveMailingListRule flag is not set, operation continues to step 1365. If the RemoveMailingListRule flag is set, operation continues to step 1360 where the rule is removed. Removing the mailing list rule prevents subsequent messages received from the indicated message source from being automatically placed in the user's junk mail folder. Operation then continues from step 1360 to step 1365.

The mail server receiving the not junk request may add a mailing list associated with a received message to a mailing list allowed senders list if the appropriate flag is set in the not junk request. A determination is made as to whether AddToMailingList flag is set at step 1365. If the AddToMailingList flag is not set, operation continues to step 1375. If the AddToMailingList flag is set, operation continues to step 1370. The recipient of the received message is added to the user's mailing list allowed senders list at step 1370. This allows subsequent messages received from the particular mailing list to be placed in the user's inbox. Operation then continues to step 1375.

Another flag that may be set in the not junk request is the MoveToJunkFolder. If the flag is set appropriately during method 1200, it may indicate that a particular message should be moved out of the user's junk mail folder. A determination in made as to whether a MoveToJunkFolder flag is set at step 1375. If the MoveToJunkFolder flag is not set, operation continues to step 1385 where processing of the not junk request is complete. If the MoveToJunkFolder flag is set, operation continues to step 1380 where the message is moved to the inbox folder of the user. In one embodiment, the MoveToJunkFolder flag is set to false to indicate that the message should be moved to the inbox. In another embodiment, a separate flag, for example, a MoveToInboxFolder flag, may be used to indicate that the received message should be moved to the inbox. After the received message is moved to the inbox at step 1380, operation continues to step 1385 where processing of the not junk request is complete.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for processing a message, comprising:
receiving a message;
determining one of at least three safety levels for the message;
providing safety level information in an interface, the safety level information associated with the selected safety level.

2. The method of claim 1, wherein said step of determining one of at least three safety levels includes:
determining whether the message failed a sender identification query.

3. The method of claim 1, wherein said step of determining one of at least three safety levels includes:
determining whether the message is from a known sender.

4. The method of claim 1, wherein said step of determining one of at least three safety levels includes:
determining the message is associated with a mailing list.

5. The method of claim 1, further comprising:
processing the message in response to input received from a user through the interface, the processing associated with the safety level of the message.

6. The method of claim 5, wherein said step of processing includes:
sending an unsubscribe email to an unsubscribe address.

7. The method of claim 5, wherein said step of processing includes:
opening an unsubscribe URL.

8. The method of claim 5, wherein said step of processing includes:
blocking subsequent messages associated with the domain of the received message.

9. The method of claim 5, wherein said step of processing includes:
determining the source address of the received message failed an DNS query; and
preventing the source address from being added to a user block list.

10. The method of claim 5, wherein said step of processing includes:
allowing subsequent messages associated with the domain of the received message.

11. The method of claim 5, wherein said step of processing includes:
sending a Non-Delivered Report to the source of the received message, the Non-Delivered Report indicating that no user exists for the received message.

12. The method of claim 5, wherein said step of determining one of at least three safety levels for the message includes determining a safety level of medium safe, said step of processing including allowing or deleting the message in response to user input received through the interface.

13. The method of claim 1, wherein the safety level information includes a safety level notification if the safety level is not safe.

14. The method of claim 1, wherein said step of determining one of at least three safety levels includes:
determining the message is a newsletter; and
selecting a safety level of safe.

15. A method for providing an electronic mail service, comprising:
providing a plurality of mail servers by an electronic mail provider;
receiving an electronic message for a user having an account with the electronic mail provider, the electronic message received by one of the plurality of mail servers;
determining one of at least three safety levels for the message by one or more of the plurality of mail servers; and
providing an interface for the user having safety level information associated with the selected safety level.

16. The method of claim 15, wherein the interface is provided to a browser application over a network.

17. One or more processor readable storage devices having processor readable code embodied on one or more said processor readable storage devices, said processor readable code for programming one or more processors to perform a method, the method comprising:
accessing an electronic message sent to a recipient from a sender;
determining a safety level of the electronic message; and
processing the electronic message in response to receiving safety level input from a user.

18. The one or more processor readable storage devices of claim 17, the method further comprising:
providing safety level information regarding the message to a user through an interface.

19. The one or more processor readable storage devices of claim 17, wherein determining the safety level of the message includes determining the source of the electronic message.

20. The one or more processor readable storage devices of claim 17, wherein determining a safety level includes determining the electronic message is associated with a mailing list.
